(19) United States
(12) Patent Application Publication
(10) Pub. No.: US 2006/0228680 A1
(43) Pub. Date: Oct. 12, 2006

(54) Overhead abacus

(76) Inventor: Joan Cotter, Hutchinson, MN (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(21) Appl. No.: 10/453,132

(22) Filed: Jun. 3, 2003

(51) Int. Cl. G09B 19/02

(52) U.S. Cl. 434/188

(57) ABSTRACT

An abacus including a frame, a plurality of wires supported by the frame, and a plurality of counting members coupled to the wires for movement along the wires. The counting members are substantially translucent so to allow light to pass therethrough.

### FIELD OF THE INVENTION

This invention relates generally to teaching aids used with overhead projectors, and more particularly to a device for aiding the teaching mathematics using overhead projectors.

### BACKGROUND OF THE INVENTION

An abacus is a mechanical aid used for counting in which a user mentally performing calculations uses the abacus to keep track of sums, carries, etc. An abacus may be used to help students learn to perform simple arithmetic, such as addition, subtraction, multiplication, and division. Also, an abacus may be used to perform more complex mathematical functions, including extracting square roots and cubic roots. In its most basic construction, an abacus includes a frame supporting multiple wires or rods having beads slidably mounted thereon. In other constructions, an abacus includes a frame having multiple grooves or channels formed therein, and beads are positionable and movable along the channels. Several types of abaci exist, with each type being utilized in a particular manner to perform the previously-mentioned arithmetic operations and mathematical functions.

### SUMMARY OF THE INVENTION

The present invention provides an abacus including a frame, a plurality of wires supported by the frame, and a plurality of counting members coupled to the wires for movement along the wires. Unlike in conventional abaci, the counting members of the present abacus are substantially translucent so to allow light to pass therethrough.

Another construction of the present invention provides an abacus including a frame configured with a plurality of channels, and a plurality of counting members supported by the channels for movement along the channels. The counting members are substantially translucent so to allow light to pass therethrough.

Yet another construction of the present invention provides an abacus including a frame, a plurality of spaced, substantially parallel wires supported by the frame, and a plurality of counting members configured with at least two substantially parallel surfaces in which the counting members are coupled to the wires at portions of the counting members offset from the center of gravity of the counting members. The counting members are movable along the wires.

Other features and aspects of the present invention will become apparent to those skilled in the art upon review of the following drawings, detailed description, and claims.

### BRIEF DESCRIPTION OF THE DRAWINGS

In the drawings, wherein like reference numerals indicate like parts:

FIG. 1 is a perspective view of a conventional Chinese abacus;

FIG. 2 is a perspective view one construction of an abacus embodying the present invention, the abacus being positioned on a viewing surface of an overhead projector;

FIG. 3 is a side view of the abacus and the overhead projector of FIG. 2, illustrating a section through the abacus;

FIG. 4 is an enlarged perspective view of the abacus of FIG. 2, illustrating a partial section through a few individual counting members; and

FIG. 5 is an enlarged perspective view of another construction of an abacus embodying the present invention, illustrating a partial section of a portion of the abacus.

Before at least one embodiment of the invention is explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that the phraseology and terminology used herein is for the purpose of description and should not be regarded as limited.

### DETAILED DESCRIPTION

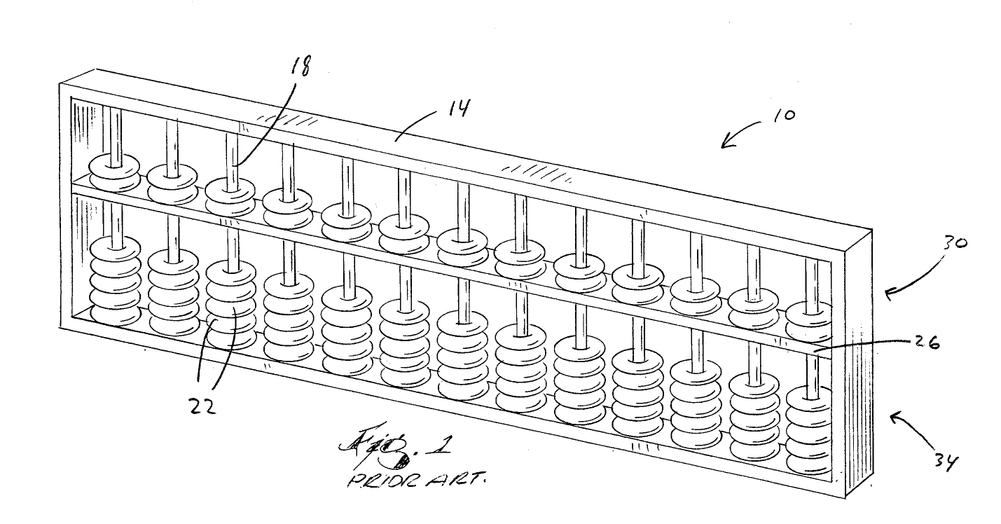

A conventional Chinese abacus 10 is shown in FIG. 1. The Chinese abacus 10 of FIG. 1, as the case is with most abaci, is typically constructed wood and comes in varying sizes. The abacus 10 includes a frame 14 supporting a series of rods 18 in a spaced and parallel configuration. Multiple wooden beads 22 slide freely along the rods 18 so that they can be positioned as needed. In the illustrated abacus 10 of FIG. 1, a total of seven wooden beads 22 are supported by each rod 18. A separator beam 26 divides the abacus 10 into an upper deck 30 and a lower deck 34, such that the wooden beads 22 are separated along the length of each rod 18. Each rod 18 includes two wooden beads 22 positioned in the upper deck 30, while the remaining five wooden beads 22 are positioned in the lower deck 34.

During general use of the Chinese abacus 10, each wooden bead 22 in the upper deck 30 has a value of “5,” while each wooden bead 22 in the lower deck 34 has a value of “1.” As illustrated in FIG. 1, the right-most column of wooden beads 22 is the “ones” column, the next adjacent column of wooden beads 22 to the left is the “tens” column, the next adjacent column of wooden beads 22 to the left is the “hundreds” column, and so on. In any particular column, after five wooden beads 22 are counted in the lower deck 34, the result is carried to the upper deck 30. After both beads 22 in the upper deck 30 are counted, the result (being “10”) is then carried to the next adjacent column of wooden beads 22 to the left.

An abacus 10 such as that illustrated in FIG. 1 may be used to help students learn to perform simple arithmetic. In classroom teaching practices involving each student using an abacus 10, it is often required of the teacher to stand in front of the classroom and use the abacus 10 to provide instructions and/or give examples to the students so they may follow along. In such a case, it is often difficult for the teacher to adequately communicate their instructions and/or examples to the students through a small, hand-held abacus 10 while standing in front of the classroom. As a result, some students may not be able to see the teacher's abacus 10 or how the teacher is moving the wooden beads 22. This may lead to students becoming frustrated, distracted, or otherwise disinterested in the lesson being taught since they can not follow the teacher's instructions and/or examples.

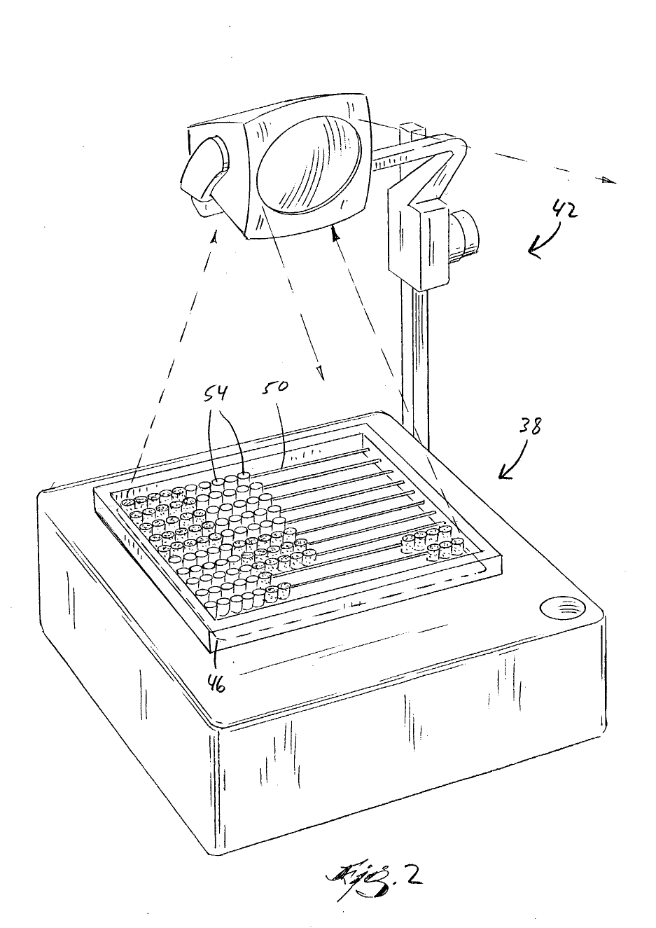

With reference to FIG. 2, an abacus 38 in accordance with the present invention is shown configured for use with an overhead projector 42. Abacus 38 includes a frame 46 supporting multiple wires 50 thereon. Wires 50 are supported on frame 46 in a spaced and substantially parallel configuration. Although the exemplary construction of abacus 38 of FIG. 2 includes a generally rectangular-shaped frame 46, other constructions of the abacus (not shown) may utilize frames having other shapes, including circular, ovular, trapezoidal, pentagonal, hexagonal, heptagonal, and so forth. Also, although frame 46 is made from wood in the construction of FIG. 2, it may be made from any number of different materials, including metal, plastic, composite materials, and so forth. Further, frame 46 may be made from a clear or translucent plastic material, such that light is allowed to transmit or pass through frame 46.

Wires 50 include opposite end portions 52 inserted into apertures (not shown) in the frame 46 for support therein. Wires 50 are made from a relatively rigid, thin-gauge metal rod in the exemplary construction of FIG. 2. Wires 50, however, are not limited to any particular range of stiffness, such that wires 50 of the present invention may be in the form of rigid rods, semi-rigid wires, or flexible string or filament, among other forms. Wires 50 may also be made from any number of different materials, including wood, plastic, composite materials, string, flexible filament, and so forth. Further, wires 50 may be made from a clear or translucent plastic material, such that light is allowed to transmit or pass through wires 50.

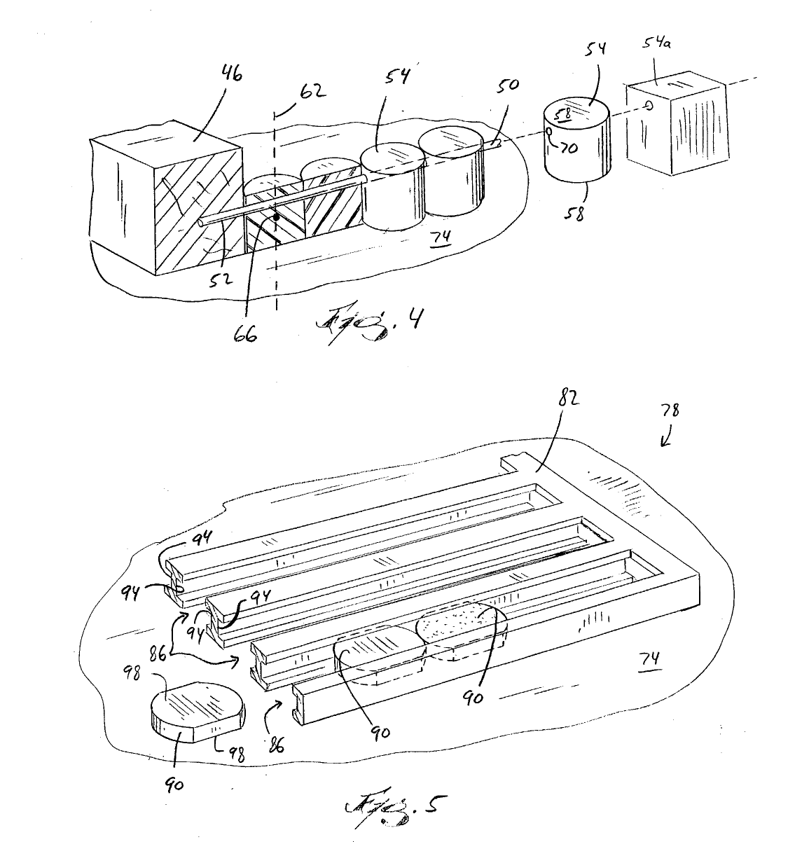

As shown in FIGS. 2-4, wires 50 support multiple translucent counting members in the form of beads 54 along the length of wires 50 such that the beads 54 are allowed to slide freely along wires 50. Beads 54 are loosely supported on wires 50 such that they may easily spin or rotate on wires 50. Beads 54 are generally configured as translucent cylinders having substantially parallel opposite ends 58. In other constructions of the abacus, the beads may be configured in any shape having two substantially parallel surfaces (e.g., cube 54a, see FIG. 4). Alternatively, the beads may be configured with a singular substantially flat surface (e.g., a pyramid), or without any parallel surfaces (e.g., sphere). As will be further described below, the configuration of beads 54 determines in part the brightness of the beads 54 as seen on a projection screen (not shown). The opposite ends 58 of each bead 54 are substantially parallel to allow light to pass through one of the ends 58, through bead 54, and through the other end 58. Also, the opposite ends 58 of each bead 54 are polished to enhance the amount of light transmitted through each bead 54. Alternatively, intermediate outer surfaces (e.g., the circumferential outer surfaces of beads 54) between opposite ends 58 may be coated or formed with a reflective coating, such that light entering one end 58 of bead 54 is reflected throughout the interior of bead 54 before passing through the opposite end 58 of bead 54. Also, beads 54 may be colored such that only a particular range of wavelengths of light are transmitted through the beads and projected onto the projection screen by the overhead projector 42. Alternatively, only the ends 58 of beads 54 may be colored, and the intermediate surfaces between the ends 58 are colorless.

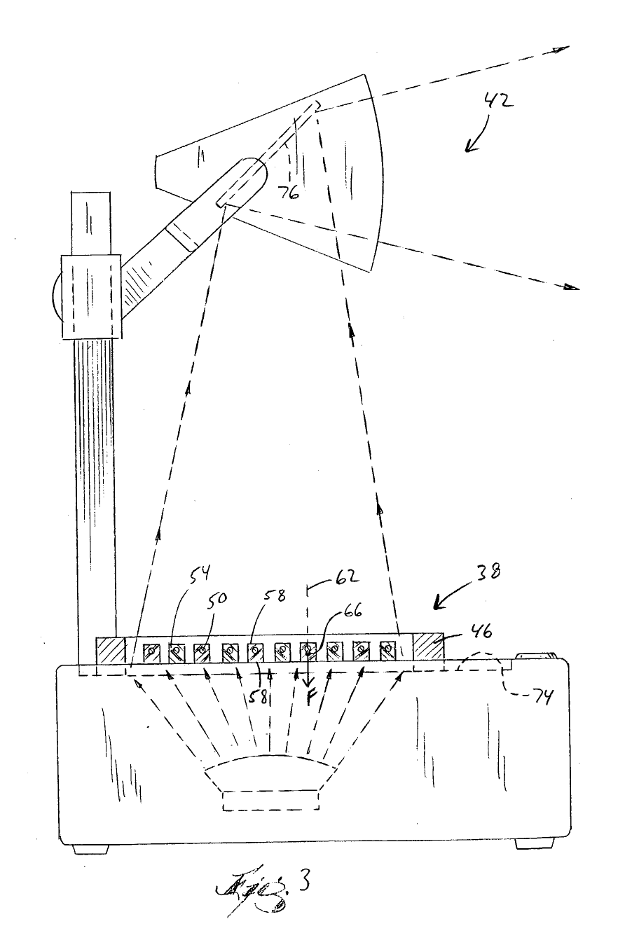

As shown in FIGS. 3-4, each bead 54 defines a central axis 62 passing through the opposite ends 58 of each bead 54 and a center of gravity 66. In the exemplary configuration of the beads 54 in FIG. 3, the center of gravity 66 of each bead 54 lies along the central axis 62 substantially equidistant from the opposite ends 58 of each bead 54. Also, as shown in FIG. 4, beads 54 include apertures 70 therethrough to allow insertion of wires 50 to support the beads. Apertures 70 are positioned in beads 54 such that the apertures pass through central axis 62 and are offset from the center of gravity 66 of the beads 54. As a result, wires 50 appear biased toward one end 58 of the beads 54.

Due to the mounting configuration of beads 54 on wires 50, the beads tend to naturally orient themselves on the wires 50 with respect to the orientation of the frame 46. This is due to the gravitational forces acting on the beads 54 at their center of gravity 66. If, at any time, a gravitational force vector “F” acting on the center of gravity 66 of any particular bead is not intersecting the wire supporting the particular bead, the gravitational force vector “F” creates a moment about the wire 50. As a result, the bead will rotate until the gravitational force vector “F” intersects the wire 50 supporting the bead.

With reference to FIG. 2, the abacus 38 is shown supported on a substantially flat and level viewing surface 74 of a transmissive-type overhead projector 42. Frame 46 rests on viewing surface 74 to support beads 54 a distance from viewing surface 74. During use, beads 54 may be moved along wires 50 with little regard as to their orientation, since beads 54 naturally orient themselves on the wires 50, as a result of the gravitational forces acting at the center of gravity 66 of the beads, such that the ends 58 of the beads remain substantially parallel with viewing surface 74. Therefore, light is allowed to project from viewing surface 74, transmit through beads 54, be reflected by a lens assembly 76, and project onto the projection screen. Alternatively, in other configurations of an overhead projector, such as a reflective-type overhead projector (not shown), the light may originate from above the abacus 38 and reflect back to the lens assembly before projecting onto the projection screen. Also, beads 54 may be supported by wires 50 relative to frame 46 such that the ends 58 of beads 54 abut viewing surface 74 of overhead projector 42, such that the ends 58 of beads 54 are forced to be parallel with viewing surface 74. In a construction of frame 46 utilizing a clear or translucent plastic material, markings on frame 46 (e.g., labels indicating the “10's” column, the “100's” column, and so forth) may also be projected onto the projection screen.

The brightness of any particular bead 54 as seen on the projection screen is dependent upon the beads orientation on the wires 50. For the cylindrical bead configuration of FIGS. 2-4, for example, beads 54 appear brightest on the projection screen when ends 58 of the beads 54 are substantially parallel with the viewing surface 74 and the central axis 62 is substantially perpendicular to the viewing surface 74. As a particular bead 54 is re-oriented on a particular wire 50, such that ends 58 of the beads 54 are no longer substantially parallel with the viewing surface 74, the amount of light transmitted through bead 54, reflected by lens assembly 76, and projected upon the projection screen is decreased. As a result, the particular bead 54 appears dim on the projection screen. Further, it may be difficult for a student to determine the color of the dim bead 54, which in effect may hamper the students learning. In a construction of an abacus (not shown) utilizing beads configured with a singular substantially flat surface (e.g., a pyramid), the brightness of the pyramidal bead (as seen on the projection screen) may appear to be about the same as bead 54, provided the substantially flat surface of the pyramidal bead (i.e., the base of the pyramid) is substantially parallel with viewing surface 74 and facing upwards (toward lens assembly 76). In a construction of an abacus (not shown) utilizing beads configured without substantially parallel surfaces (e.g., a sphere), the brightness of such beads (as seen on the projection screen) may not appear to be about the same as bead 54 having substantially parallel surfaces (e.g., opposite ends 58).

With reference to FIG. 4, another construction of an abacus 78 configured for use with the overhead projector 42 is shown. Abacus 78 includes a frame 82 configured with multiple channels 86 to support translucent beads 90 therein. Channels 86 are spaced from one another in a substantially parallel configuration, and include opposing C-shaped grooves 94 to secure beads 90 there between. Like frame 46 illustrated in FIG. 2, frame 82 includes a generally rectangular-shape, however other constructions of the abacus (not shown) may utilize frames having other shapes, including circular, ovular, trapezoidal, pentagonal, hexagonal, heptagonal, and so forth. Frame 82 and channels 86 may be made from wood, and assembled and secured together according to any number of conventional methods. However, frame 82 and channels 86 may also be made from any number of different materials, including metal, plastic, composite materials, and so forth.

Beads 90 of FIG. 4 are generally configured as translucent disks having substantially parallel opposite ends 98. In other constructions of the abacus (not shown), the beads may be configured in any shape having two substantially parallel surfaces. The opposite ends 98 of each bead 90 are substantially parallel to allow light to pass through one of the ends 98, through bead 90, and through the other end 98. Also, the beads 90 may be colored such that only a particular range of wavelengths of light are transmitted through the beads 90 and projected onto the projection screen by the overhead projector 42. Further, beads 90 may be configured in any manner consistent with the alternative bead configurations described above.

When used in combination with overhead projector 42, frame 82 is supported by viewing surface 74 of projector 42, while beads 90 are supported by channels 86 a distance from viewing surface 74 such that the ends 98 of beads 90 are substantially parallel with viewing surface 74. Accordingly, light is allowed to project from viewing surface 74, transmit through beads 90, be reflected by the lens assembly 76, and project onto a projection screen. Alternatively, in other configurations of an overhead projector, such as a reflective-type overhead projector (not shown), the light may originate from above abacus 78 and reflect back to the lens assembly before projecting onto the projection screen. Also, in another construction of the channels (not shown), the channels may include two opposing L-shaped grooves, such that beads 90 may be removed from the channels.

In accordance with the abaci 38, 78 of FIGS. 2 and 4, different colors are utilized on the beads 54, 90 to differentiate the beads 54, 90 into groups. More particularly, ten beads 54, 90 are arranged on each wire 50 or channel 86, respectively, in two groups of five beads 54, 90. The two groups each have a different color, such that a student viewing either abacus 38, 78 will be able to differentiate between the two groups, and recognize that each color group represents a group of five beads 54, 90, or items. Alternatively, any number of different colors may be used with the beads 54, 90.

While the present invention is described above in connection with preferred or illustrative embodiments, these embodiments are not intended to be exhaustive or limiting of the invention. Rather, the invention is intended to cover all alternatives, modifications, and equivalents included within its spirit and scope, as defined by the appended claims.

I claim:

1. An abacus comprising:
a frame;
a plurality of wires supported by the frame; and
a plurality of counting members coupled to the wires for movement along the wires, the counting members being substantially translucent so to allow light to pass therethrough.

2. The abacus of claim 1, wherein the counting members are configured with at least one substantially flat surface allowing light to pass therethrough.

3. The abacus of claim 2, wherein each counting member includes a center of gravity, and wherein the counting members couple to the wires through portions of the counting members offset from the center of gravity of the counting members.

4. The abacus of claim 3, wherein the counting members include a central axis passing through the at least one substantially flat surface, and wherein the wires pass through the central axis of the counting members.

5. The abacus of claim 1, wherein the counting members are configured with at least two opposing surfaces.

6. The abacus of claim 5, wherein the at least two opposing surfaces are configured as at least two substantially parallel surfaces.

7. The abacus of claim 6, wherein the counting members are in the form of beads configured as cylinders, opposing ends of each cylinder defining the at least two substantially parallel surfaces.

8. The abacus of claim 5, wherein each counting member includes a center of gravity, and wherein the counting members couple to the wires through portions of the counting members offset from the center of gravity of the counting members.

9. The abacus of claim 8, wherein the counting members include a central axis passing through the at least two opposing surfaces, and wherein the wires pass through the central axis of the counting members.

10. The abacus of claim 5, wherein the frame is configured to be supported on a viewing surface of an overhead projector.

11. The abacus of claim 10, wherein the counting members are configured to naturally orient their at least two opposing surfaces with the viewing surface of the overhead projector.

12. An abacus comprising:
a frame configured with a plurality of channels; and
a plurality of counting members supported by the channels for movement along the channels, the counting members being substantially translucent so to allow light to pass therethrough.

13. The abacus of claim 12, wherein the counting members are configured with at least one substantially flat surface allowing light to pass therethrough.

14. The abacus of claim 13, wherein the frame is configured to be supported on a viewing surface of an overhead projector.

15. The abacus of claim 14, wherein the channels support the counting members therein, such that the at least one substantially flat surface of the counting members is generally oriented with the viewing surface of the overhead.

16. The abacus of claim 12, wherein the counting members are configured with at least two opposing surfaces allowing light to pass there through.

17. The abacus of claim 16, wherein the at least two opposing surfaces are configured as at least two substantially parallel surfaces.

18. The abacus of claim 17, wherein the counting members are in the form of beads configured as disks, opposing ends of each disk defining the at least two substantially parallel surfaces.

19. The abacus of claim 16, wherein the frame is configured to be supported on a viewing surface of an overhead projector.

20. The abacus of claim 19, wherein the channels support the counting members therein, such that the at least two opposing surfaces of the counting members are generally oriented with the viewing surface of the overhead.

21. An abacus comprising:
a frame;
a plurality of spaced, substantially parallel wires supported by the frame; and
a plurality of counting members configured with at least two substantially parallel surfaces allowing light to pass there through, each counting member having a center of gravity,
wherein the counting members are coupled to the wires at portions of the counting members offset from the center of gravity of the counting members, the counting members being movable along the wires.

22. The abacus of claim 21, wherein the counting members include a central axis passing through the at least two substantially parallel surfaces, the wires passing through the central axis of the counting members.
